(19) United States
(12) Patent Application Publication
(10) Pub. No.: US 2015/0245977 A1
(43) Pub. Date: Sep. 3, 2015

(54) REHABILITATION DEVICE

(71) Applicants: Arno Sarkis Sungarian, Shrewsbury, MA (US); Stephen Michael Desio, Northboro, MA (US)

(72) Inventors: Arno Sarkis Sungarian, Shrewsbury, MA (US); Stephen Michael Desio, Northboro, MA (US)

(21) Appl. No.: 14/194,624

(22) Filed: Feb. 28, 2014

(51) Int. Cl. A61H 15/00

(52) U.S. Cl. CPC A61H 15/00

(57) ABSTRACT

A rehabilitation device is provided. The rehabilitation device may include a plurality of modular canes, a plurality of rollers, at least one divider, a first end cap and a second end cap. Each tubular modular cane may terminate in the first end and an opposing second end. The second end diameter may be sized to slidably receive the first end. The second end cap may have a second connection end sized to slidably receive the first end. The first end cap may have first connection end adapted to slidably receive the second end. The plurality of rollers may be made of compressible material. The plurality of rollers may be mounted on the plurality of modular canes so that the rehabilitation device may have an adjustable length with interchangeable rollers. The plurality of rollers may be separated by at least one divider so as to adjust the spacing of the plurality of rollers.

### CROSS-REFERENCE TO RELATED APPLICATION

This application claims the benefit of priority of U.S. provisional application No. 61720517 filed 28 Feb 2013, the contents of which are herein incorporated by reference.

### BACKGROUND OF THE INVENTION

The present invention relates to medical rehabilitation and treatments and, more particularly, to a device for rehabbing and treating painful soft tissues and scar breakdown.

Currently, message implements are bulky, used for a single or limited purpose and or do not allow for adequate treatment of different body parts and conditions. The existing devices function on the principle “one size fits all.” As a result, patients are forced to use various, non-compatible devices to address their multi-faceted needs. This in turn results in patients foregoing treatment, increased expenses as well as problems with clutter and storage. Moreover, the current devices are not designed to simultaneously treating different muscle groups.

As can be seen, there is a need for a compact device that can be reconfigured to target different anatomic areas while applying a physiological approach, including simultaneously treatment of different muscle groups.

### SUMMARY OF THE INVENTION

In one aspect of the present invention, a rehabilitation device comprises: a tubular modular cane terminating in a first end and a second end; and at least one roller rotatably mounted on the modular cane, wherein the at least one roller provides a compressible surface, whereby the at least one roller is interchangeable.

In another aspect of the present invention, a method of self-implementing no-hands rehabilitation to a predetermined body part comprising: providing a rehabilitation device comprising: at least one tubular modular cane terminating in a first end and a second end, wherein the second end is configured to slidably receive the first end; and two adjacent rollers rotatably mounted on the at least one modular cane, wherein each roller provides a compressible surface shaped so that the outer contour of the two adjacent rollers taper toward each other; conforming the two rollers to two different portions of a predetermined body part; and rolling the two portions of the predetermined body part over the rollers, whereby pressure is applied by self-weight.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is a perspective view of an exemplary embodiment of the present invention;

FIG. 3 is an exploded perspective view of an exemplary embodiment of the present invention

FIG. 4 is a section detail view of an exemplary embodiment of the present invention, taken along line 4-4 in FIG. 2;

FIG. 5 is a section detail view of an exemplary embodiment of a springed-pin of the present invention;

FIG. 6 is a section detail view of an exemplary embodiment of the present invention, illustrating a removable connection of a plurality of modular canes;

FIG. 7 is a section detail view of an exemplary embodiment of the present invention, taken along line 7-7 in FIG. 2;

FIG. 8 is a perspective view of an exemplary embodiment of the present invention;

FIG. 9 is a perspective view of an exemplary embodiment of the present invention;

FIG. 10 is a perspective view of an exemplary embodiment of the present invention; and

FIG. 11 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a rehabilitation device. The rehabilitation device may include a plurality of modular canes, a plurality of rollers, at least one divider, a first end cap and a second end cap. Each tubular modular cane may terminate in the first end and an opposing second end. The second end diameter may be sized to slidably receive the first end. The second end cap may have a second connection end sized to slidably receive the first end. The first end cap may have first connection end adapted to slidably receive the second end. The plurality of rollers may be made of compressible material. The plurality of rollers may be mounted on the plurality of modular canes so that the rehabilitation device may have an adjustable length with interchangeable rollers. The plurality of rollers may be separated by at least one divider so as to adjust the spacing of the plurality of rollers.

In certain embodiments, the rehabilitation device may include two rollers rotatably mounted to the modular cane. Because of the size and shape of the rollers the rehabilitation device may be able to conform to selected areas of the body. Such conformity to the selected body part enables self-administration of the rehabilitation device by use of self-weight without the use of any hands. The user may roll a portion of the selected body parts under self-weight over the two rollers.

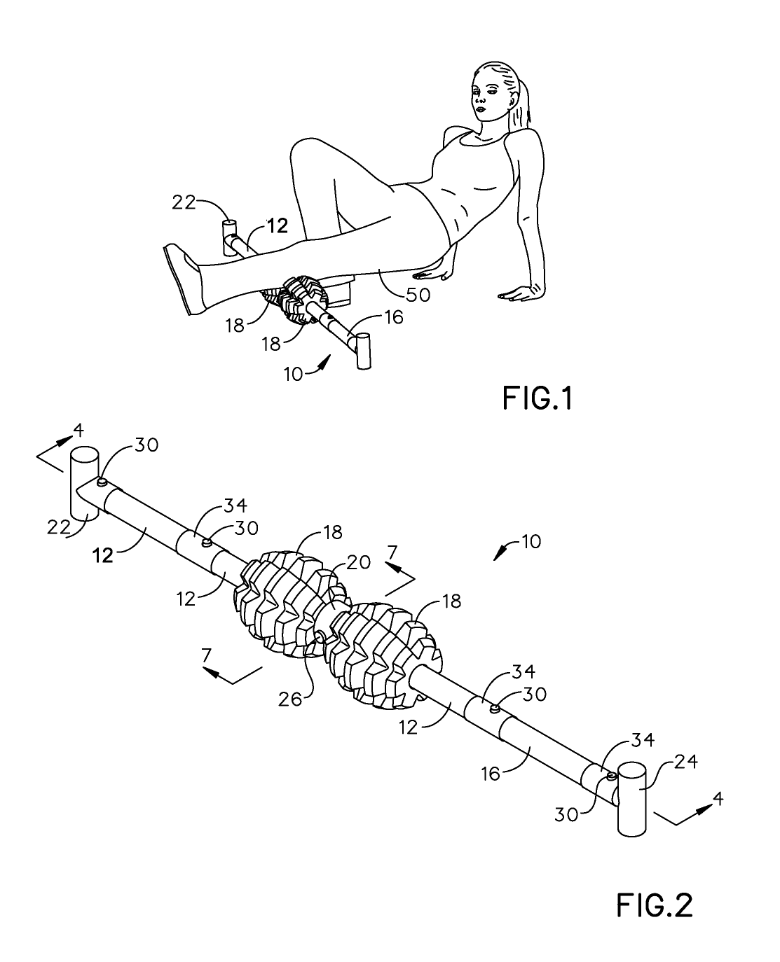

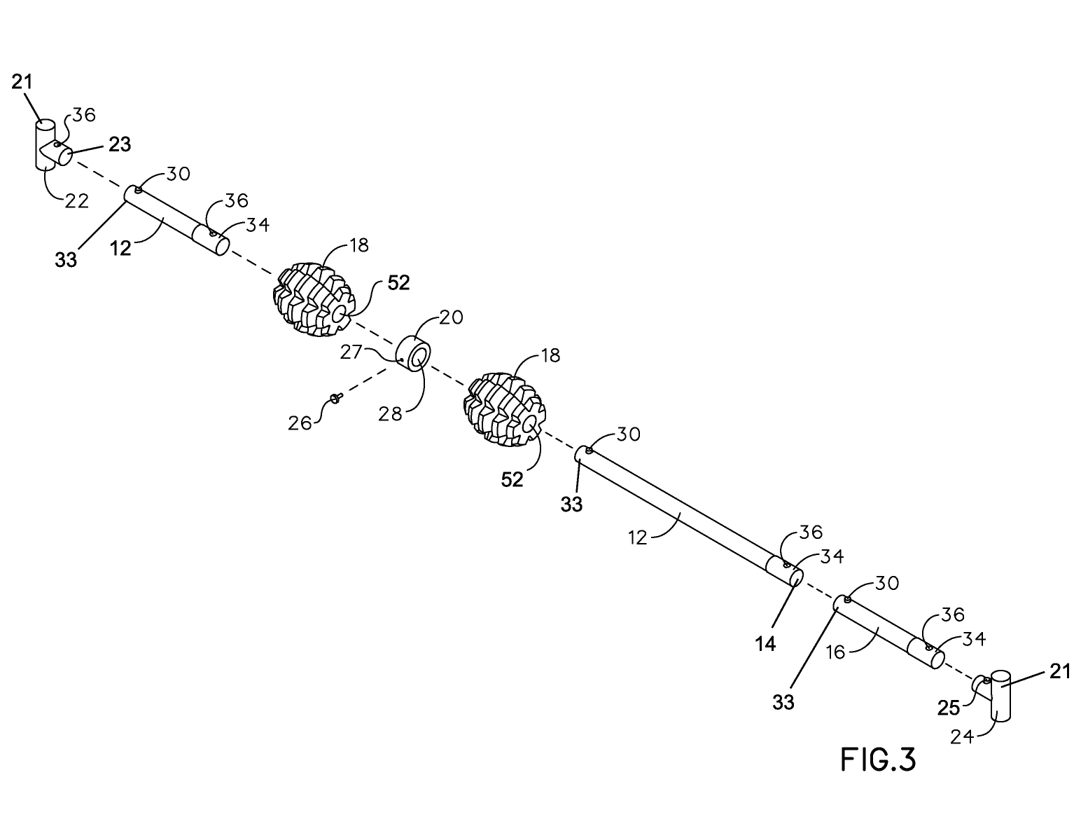

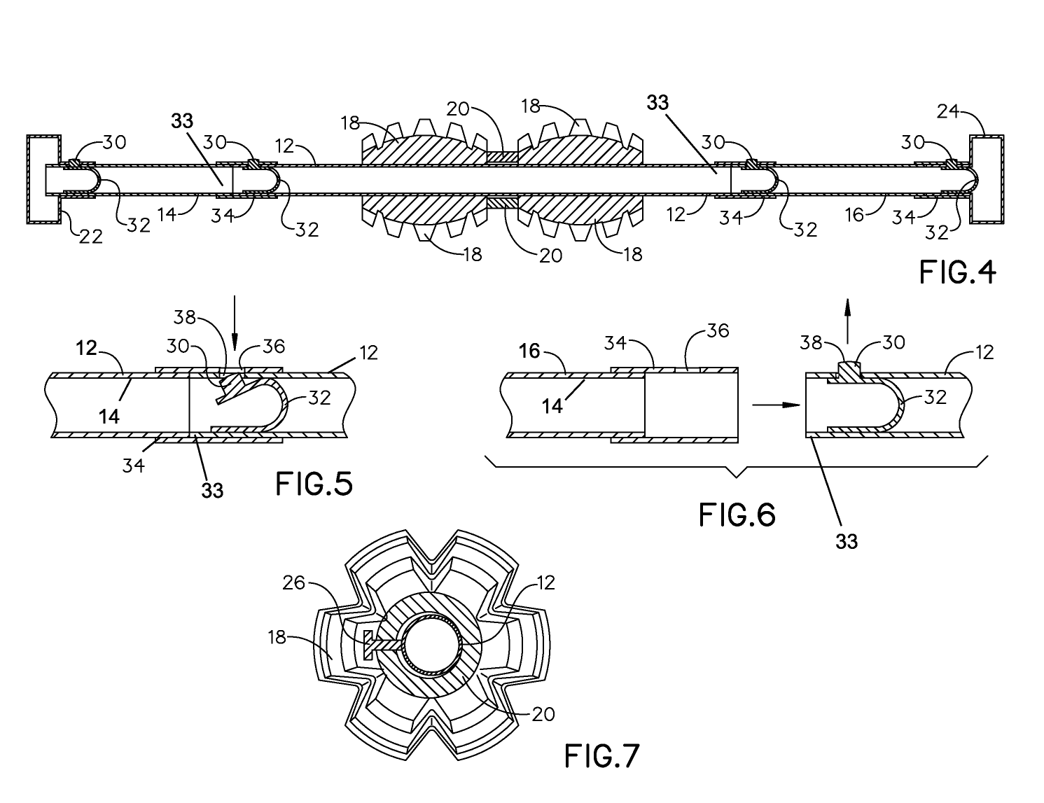

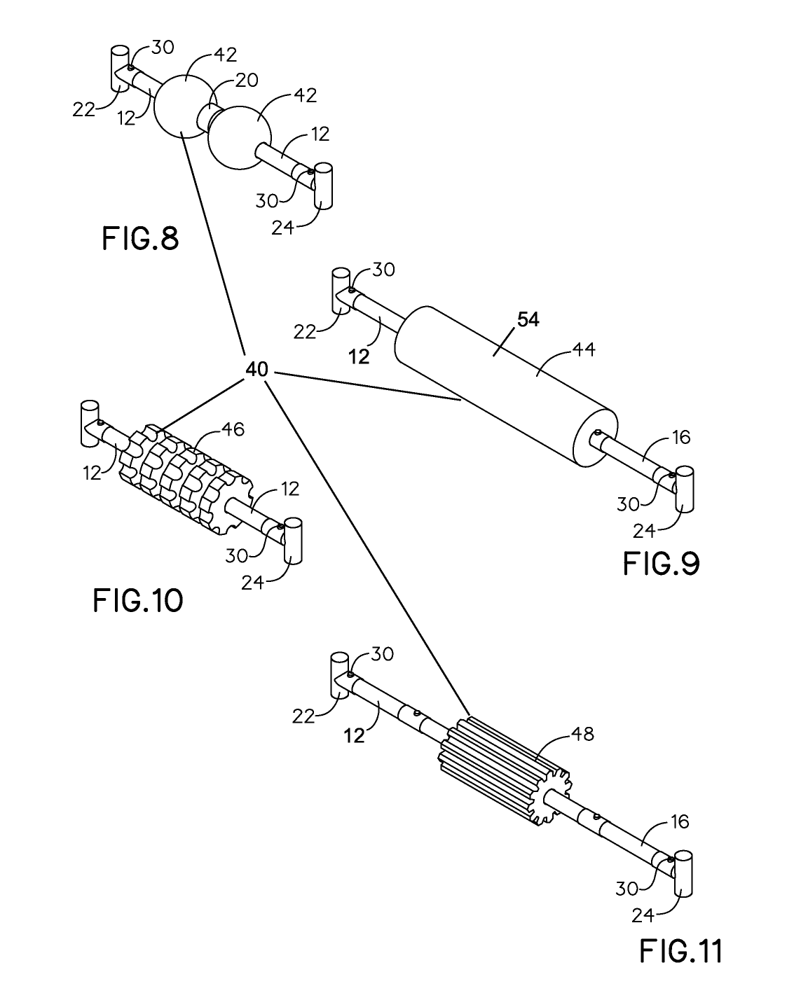

Referring to FIGS. 1 through 11, the present invention may include a rehabilitation device 10. The rehabilitation device 10 may include a plurality of modular canes 12, a plurality of rollers 40, at least one divider 20, a first end cap 22 and a second end cap 24.

The plurality of modular canes 12 may be tubes of various lengths and be made of lightweight material that can be repeatedly bent without fracturing, such as aluminum, polyethylene, polypropylene, various impregnated or laminated fibrous materials, various plasticized materials and the like. Each tubular modular cane 12 may define an interior surface 14 and an exterior surface 16. The modular cane 12 may include a plurality of pinholes 36, a plurality of springed pins 38, a plurality of first ends 33, a plurality of second ends 34 adapted to removably connect together to form various lengths for various rehabilitation needs of a user 50.

Each tubular modular cane 12 may terminate in the first end 33 and an opposing second end 34. At least one pinhole 36 may be disposed near each first end 33 and near each second end 34. The first end 33 may include a springed-pin 38. The second end 34 may have an interior surface 14 diameter slightly larger than the diameter of the first end 33 exterior surface 16. The second end 34 diameter may be sized to slidably receive the first end 33. The first end 33 exterior surface 16 may slidably engage the interior surface 14 of the second end 34.

Each springed-pin 38 may include a button 30 connected to a spring 32. The spring 32 may be connected to the interior surface 14. Each spring 32 may bias one button 30 so that the button 30 protrudes through the opposing interior surface 14 and out of an adjacent pinhole 36 so as to protrude above the exterior surface 16.

Each second end cap 24 and each first end cap 22 may be a tube having a handle end 21. Each second end cap 24 may have a second connection end. Each first end cap 22 may have a first connection end 23. Each connection end may extend perpendicularly from about the middle of the handle end 21 forming a ‘T’ shape. A pair of handle ends 21 may be adapted to support the rehabilitation device 10 when in use, as illustrated in FIG. 1. The second end cap 24 may have one springed-pin 38 disposed near the second connection end 25. The first end cap 22 may have one pinhole 36 disposed near the first connection end 23. The second connection end 25 interior surface diameter may be sized to slidably receive the first end 33 exterior surface 16. The first connection end 23 exterior surface may slidably engage the interior surface 14 of the second end 34.

The plurality of rollers 40 may be tubular elements having an interior roller surface 52 and an exterior roller surface 54. The plurality of rollers 40 may be made of material that is conducive to storing thermal energy. For example, such material may be heated by a heat source and or cooled by a cooling source. The plurality of rollers 40 may be made of compressible material such as but not limited to foam and the like. The plurality of rollers 40 may be sized to conform the rehabilitation device 10 to selected areas of the body. The interior roller surface 52 may be rotatably mounted to each modular cane 12 exterior surface 16. The plurality of rollers 40 may include a smooth roller 44, a contoured roller, a textured roller 18, 46, a grooved roller and a ribbed roller 48 of various shapes, including but not limited to spherical 42, cylindrical 44, 46, 48, oblong and the like, and sizes. The grooved rollers may include a plurality of radially projecting fingers disposed along the exterior roller surface 54. The plurality of rollers 40 may be mounted to rotate independently of each other. The plurality of rollers 40 may be separated by at least one divider 20.

The at least one divider 20 may be tubular elements adapted to slidably receive the plurality of modular canes 12. The at least one divider 20 may form a tubular opening 28 large enough so that a divider 20 may slide over the handle end 21. The at least one divider 20 may include a set screw hole 27 and a set screw 26 so as to removably attached along the modular cane 12.

In operation, the rehabilitation device 10 may be self-administered by a user 50 or the user 50 may administer the massage implement on a second person. A method of using the present invention may include the following. The rehabilitation device 10 disclosed above may be provided. The user 50 utilizing the rehabilitation device 10 may mount at least two of the plurality of rollers 40 to the modular cane 12. Because of the size and shape of the rollers 40, in certain embodiments each roller's outer contour tapers toward the other adjacent roller, the user 50 may be able to effectively conform the rehabilitation device 10 to selected areas of the body, such as but not limited to muscle groups, muscle tissue, scar tissue, tendons, trigger points and the like. Such conformity to the selected body part and between at least two of the plurality of rollers 40 enables self-administration of the rehabilitation device 10 by use of self-weight without the use of any hands, as illustrated in FIG. 1. The user 50 may roll a portion of the selected body parts under self-weight over the at least two of the plurality of rollers 40. In certain embodiments, the user may add at least one spacer 20 between the at least two of the plurality of rollers 40 to facilitate such conformity. In certain embodiments, the user 50 may self-administer by self-weight using one roller 40, such one-roller selections are illustrated in FIGS. 9 through 11.

Utilization of the user's 50 self-weight under the self-administered, no-hands system disclosed above may facilitate relaxation of the applied-to muscle tissue so as to uniquely stimulate a plurality of receptors in the muscle/tendon juncture, whereby the present invention provides superior benefits. As a result, the rehabilitations device 10 may be useful in providing physiological effects known as self-myofascial release. Myofascial release alleviates muscle pain by relieving myofascial trigger points within the muscle tissue and/or by releasing lactic acid and other toxins from a person's muscle, whereby the additional benefits of the relaxation garnered by the self-administration is within the scope of the present invention. Significantly, prior art is self-applied by gripping at least one handle.

In certain embodiments, a user 50 utilizing the rehabilitation device 10 may grasp one or both of the distal ends of the rehabilitation device 10 near the end caps 22, 24 and apply at least one of the rollers 40 to a body area to be rehabilitated. The user 50 can then apply force to one or more of the distal ends, so as to distribute the force of the at least one of the rollers 40 to the area to be rehabilitated.

The method of the invention includes the steps of selecting the appropriate one or plurality of rollers 40 and possibly at least one spacer 20 described above and then configuring the selections in an anatomically appropriate manner to rehabilitate a selected area of the body. The rehabilitation device 10 may be easily adjusted, re-adjusted, spaced and re-spaced during one physical therapy and or rehabilitation session. Likewise, the rehabilitation device 10 may be then re-configured to the specific anatomy of a different user. The plurality of rollers 40 may address different muscle groups simultaneously. The different shapes of the rollers 40 and their ready reconfigurations along the plurality of modular canes 12 may afford varied implementations across specific anatomical locations with different needs.

It should be understood, of course, that the foregoing relates to exemplary embodiments of the invention and that modifications may be made without departing from the spirit and scope of the invention as set forth in the following claims.

What is claimed is:

1. A rehabilitation device comprising:
a tubular modular cane terminating in a first end and a second end; and
at least one roller rotatably mounted on the modular cane, wherein the at least one roller provides a compressible surface,
whereby the at least one roller is interchangeable.

2. The rehabilitation device of claim 1, further including a plurality of tubular modular canes, wherein the second end is configured to slidably receive the first end of another modular cane, whereby the length of the modular cane is adjustable.

3. The rehabilitation device of claim 2, wherein the plurality of modular canes provide a pinhole near each second end and wherein each first end has a springed-pin configured to removably mate to the pinhole of a receiving second end, whereby the length of the modular cane is adjustable.

4. The rehabilitation device of claim 2, further including a first end cap and a second end cap, wherein the first end cap provides a pinhole configured to removably connect to the second end and wherein the second end cap has the springed-pin configured to removably connect to the first end.

5. The rehabilitation device of claim 2, further including at least one tubular spacer mounted on the plurality of the modular canes adjacent to the at least one roller.

6. A self-administered self-weight rehabilitation device comprising:
at least one tubular modular cane terminating in a first end and a second end, wherein the at least one modular cane in configures so that the second end removably receives the first end of another modular cane; and
two adjacent rollers rotatably mounted on the modular cane, wherein each roller provides a compressible surface shaped so that the outer contour of the two adjacent rollers taper toward each other,
whereby the two adjacent rollers are configured to conform to a specified body part.

7. The self-administered self-weight rehabilitation device of claim 6, further including at least one tubular spacer mounted between the two adjacent rollers on the at least one modular cane, whereby the spacing the two adjacent rollers are adjustable for conforming to predetermined parts of the body.

8. A method of self-implementing no-hands rehabilitation to a predetermined body part comprising:
providing a rehabilitation device comprising: at least one tubular modular cane terminating in a first end and a second end, wherein the second end is configured to slidably receive the first end; and two adjacent rollers rotatably mounted on the at least one modular cane, wherein each roller provides a compressible surface shaped so that the outer contour of the two adjacent rollers taper toward each other;
conforming the two rollers to two different portions of a predetermined body part; and
rolling the two portions of the predetermined body part over the rollers,
whereby pressure is applied by self-weight.

9. The method of claim 8, wherein the two rollers are spaced by at least one tubular spacer mounted on the modular cane adjacent to and between the two rollers.

10. The method of claim 8, wherein the two rollers have a generally spherical shape.
